(19) United States
(12) Patent Application Publication
(10) Pub. No.: US 2009/0319983 A1
(43) Pub. Date: Dec. 24, 2009

(54) Intellectual property model creating apparatus, intellectual property model creating method, and computer product

(75) Inventors: Masato Tatsuoka, Kawasaki (JP); Seiji Nakabayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/379,774

(22) Filed: Feb. 27, 2009

(30) Foreign Application Priority Data
Jun. 23, 2008 (JP) 2008-162778

(51) Int. Cl. G06F 9/44

(52) U.S. Cl. 717/104

(57) ABSTRACT

A model managing apparatus manages an intellectual property model formed by using program description to model a function to be realized as hardware. The model managing apparatus includes a data storing unit that stores and manages therein electronic system levels that are components into which the intellectual property model is divided. The components are an application program interface that defines external communications, a register that defines data to be input and output, and a behavior that defines a function or a computation. The data storing unit further stores therein connection data that defines connection relations between the register and the behavior, between behaviors, and between the behavior and the application program interface.

### CROSS REFERENCE TO RELATED APPLICATIONS

This application is based upon and claims the benefit of priority of the prior Japanese Patent Application No. 2008-162778, filed on Jun. 23, 2008, the entire contents of which are incorporated herein by reference.

### FIELD

The embodiment discussed herein is related to a model used in an upper level design concerning an abstract level model of an electronic system level (ESL) tool.

### BACKGROUND

Conventionally, a method of automatically generating a source code using a source code template has been disclosed, such as that described in Japanese Laid-Open Patent Application Publication No. 2008-052356.

Often, when an intellectual property (IP) model is developed, based on the IP model and with the aid of source code, derivations and source codes are generated. Hence, source codes respectively having minor changes exist and each of the generated source codes is repeatedly used and results in multi-fold branching. Management methods of the source code and specifications of the model in this context are according to derivation and large-scaled. Thus, the readability of the source codes is impaired, resulting in a problem in that the source codes is not reusable.

Concerning verification of the source codes developed, a partially modified source code can be verified by merely verifying the modified part. However, if the person verifying the source code is not the person who developed the source code, verification of the entire source code may not be possible; arising in a problem in that verification becomes insufficient. Thereby, a model having bugs is created, resulting in a problem in that another model is developed using the model having the bugs and the bugs are propagated to successive generations.

Thus, at present according to the method above, a template must assimilate all the derivations and, therefore, a problem has arisen in that template codes explosively increase for each derivation and the readability of the source codes is already impaired.

### SUMMARY

According to an aspect of an embodiment, a model managing apparatus manages an intellectual property model formed by using program description to model a function to be realized as hardware. The model managing apparatus includes a data storing unit that stores and manages therein electronic system levels that are components into which the intellectual property model is divided. The components are an application program interface that defines external communications, a register that defines data to be input and output, and a behavior that defines a function or a computation. The data storing unit further stores therein connection data that defines connection relations between the register and the behavior, between behaviors, and between the behavior and the application program interface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an example of an IP model according to the disclosed technique;

FIG. 2 is a schematic of the management and the creation of an IP model of the disclosed technique;

FIG. 3 is a diagram of an interface (IF) attribute list table;

FIG. 4 is a diagram of the relation between the IF attribute list table and source codes;

FIG. 5 is a diagram of a register attribute list table;

FIG. 6 is a diagram of the relation between the register attribute list table and source code;

FIG. 7 is a diagram of a behavior attribute list table;

FIG. 8 is a diagram of the relation between the behavior attribute list table and source code;

FIG. 9 is a diagram of stored contents of a connection attribute database (DB);

FIG. 10A is a diagram of an example of an IF-register connection attribute file;

FIG. 10B is a diagram of exemplary application of the IF-register connection attribute file depicted in FIG. 10A;

FIG. 11A is a diagram of an example of an IF-behavior connection attribute file;

FIG. 11B is a diagram of exemplary application of the IF-behavior connection attribute file depicted in FIG. 11A;

FIG. 12A is diagram of an example of an IF-register-behavior connection attribute file;

FIG. 12B is a diagram of exemplary application of the IF-register-behavior connection attribute file depicted in FIG. 12A;

FIG. 13A is a diagram of an example of an IF-behavior connection attribute file;

FIGS. 13B and 13C are diagrams of examples of the IF-behavior connection attribute file depicted in FIG. 13A;

FIG. 14A is diagram of an example of an inter-behavior connection attribute file;

FIG. 14B is a diagram of an example of the inter-behavior connection attribute file depicted in FIG. 14A;

FIG. 15 is a diagram of stored contents of an IP model configuration DB;

FIG. 16 is a diagram of IP model configuration data of a configuration ID: C1;

FIG. 17 is a diagram of IP model configuration data of the configuration ID: C2;

FIG. 18 is a diagram of IP model configuration data of a configuration ID: C3;

FIG. 19 is a diagram of a relation with derived items;

FIG. 20 is a diagram of a specific example of a connection attribute file used when derived items are created;

FIG. 21 is a block diagram of an IP model creating apparatus according to an embodiment;

FIG. 22 is a block diagram of a functional configuration of the IP model creating apparatus;

FIG. 23 is a diagram of an IF-register-behavior connection attribute file after conversion;

FIG. 24 is a diagram of an IF-register-behavior connection attribute file after conversion;

FIG. 25 is a diagram of IP model configuration data after conversion; and

FIG. 26 is a flowchart of an IP model creating process performed by the IP model creating apparatus.

### DESCRIPTION OF EMBODIMENT(S)

Preferred embodiments of the present invention will be explained with reference to the accompanying drawings. The disclosed technique relates to an IP model (a model used in an upper level design such as SystemC) concerning an abstract level model at a Programmer's View (PV), an Untimed (UT), a Programmer's View with Timing (PVT), a Loosely-Timed (LT), a Cycle Approximate (CX), an Approximately-Timed (AT), or a Cycle Accurate (CA) level of an Electronic System Level (ESL) tool.

As described hereinabove, conventionally, (1) addition of an internal state causes a source code to become huge and also reduces reusability. For example, when internal states are retained in one class, the content of processing (operation) differs according to the internal state even in response to the same request. The reason for this is that duties for one class are too great causing the duties to concentrate on a source code or a template that is a reference, resulting in degradation of the readability and the reusability of the source code. The number of lines becomes tremendous when the lines are fixed as one in a template, etc., degrading maintainability.

(2) Populating into a different system is impossible and a flexible framework is not built. No problem usually arises when the populating is executed within a development management system. However, when no information is provided, an IP model cannot be used when the IP model is populated into a different management system. This is because no environment exists enabling the management and extraction of information concerning the model.

Therefore, according to the disclosed technique, an IP model at the ESL is separated into three types of components (IPs) including an IF, a register, and a behavior. The IF is an IP representing the input and output of data. The register is an IP representing the storage of data. The behavior is an IP representing the behavior of the target of design using data. The three types of components each have connection relations. The three types of components and their mutual connection relations are transformed into a model. The behavior is transformed into a part. Parts may use re-factoring coding.

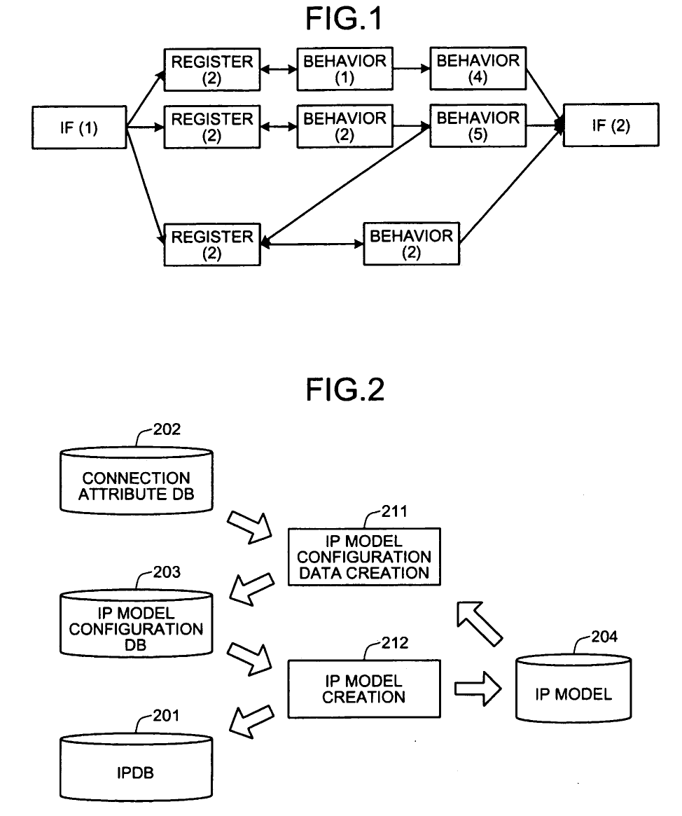

FIG. 1 is a block diagram of an example of an IP model according to the disclosed technique. In FIG. 1, rectangular blocks represent IPs, i.e., the IF, the register, or the behavior above. Arrows between IPs represent the mutual connection relations between IPs. This block configuration is IP model configuration data described hereinafter.

FIG. 2 is a schematic of the management and the creation of an IP model of the disclosed technique. In the disclosed technique, IP model configuration data creation 211 and IP model creation 212 as depicted in FIG. 1 are executed by accessing an IP data base (IPDB) 201, an IP model configuration DB 203, and a connection attribute DB 202. The stored contents of the IPDB 201, the IP model configuration DB 203, and the connection attribute DB 202 are described hereinafter.

The IP model configuration data creation 211 is processing for creating the IP model configuration data through operation of a computer by a designer. The IP model creation 212 is processing for creating an IP model by automatic execution initiated when a designer provides a creation instruction to a computer.

Through execution of the above management and creation of the IP model, reusability of the connection attributes between IPs of the IP model can be improved. Through division of each processing and localization of points to be corrected, the reusability is can be improved. With this localization, strict narrowing of the scope of the verification of a derivation can be executed. Therefore, all the derivations need not be assimilated like a template and template codes do not explosively increase for each type. Consequently, the readability of the source codes is not impaired and no bugs are propagated. Hence, the quality of the IP model is improved.

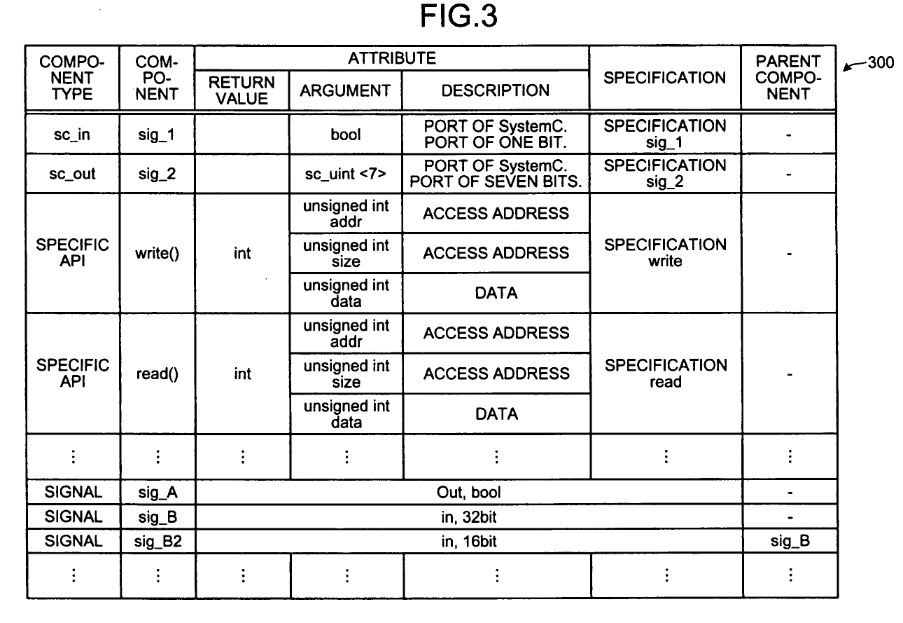

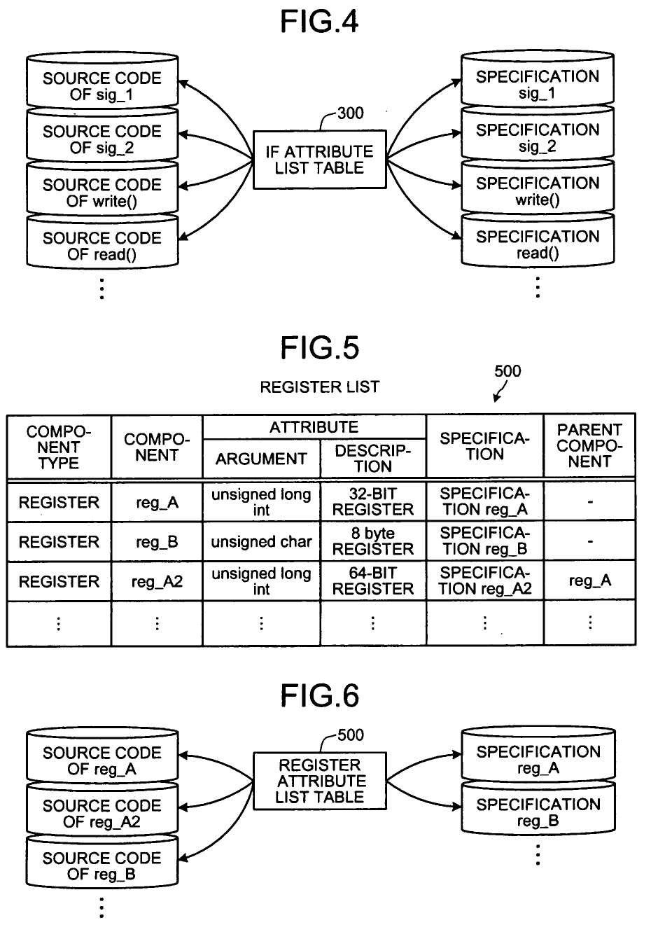

The stored contents of the IPDB 201 are described with reference to FIGS. 3 to 8. FIG. 3 is a diagram of an IF attribute list table. FIG. 4 is a diagram of the relation between the IF attribute list table and source codes. The IPDB 201 has registered therein a source code of an IP and, when an IP is newly created, the source code of the IP is entered thereto.

As depicted in FIG. 3, an IF attribute list table 300 is a table that, among the three types of components (the IF, the register, and the behavior) included in an IP model, lists attributes of the IF. The IF attribute list table 300 stores therein a type of component, a component, an attribute, a specification, and a parent component for each record. For the “type of component”, an IF is classified as a port, an application program interface (API), a signal, a clock, etc.

The “component” lists IP names that identify the specific content of the IF and stores therein a pointer to the IP. For example, a component “write( )” is linked to a source code of “write( )”. The “attribute” stores therein characteristics concerning the component (the IF). The “specification” stores therein pointers to the specification of the component (the IF). For example, a component “write( )” is linked to “specification write” that is the specification data of “write( )”. The “parent component” stores therein an IP name that is the parent of the IP of the IF, and pointers to the IP. For example, in FIG. 3, a component “Sig_B2” is a derivation of “Sig_B” and is linked to a source code of “Sig_B”.

FIG. 5 is a diagram of a register attribute list table. FIG. 6 is a diagram of the relation between the register attribute list table and source code. As depicted in FIG. 6, a register attribute list table 500 is a table that, among the three types of components (the IF, the register, and the behavior) included in an IP model, lists attributes of the register. The register attribute list table 500 stores therein the type of component, a component, an attribute, a specification, and a parent component for each record. The “type of component” indicates classification, such as a register, etc.

The “component” lists IP names that identify the specific content of the register and stores therein a pointer to the IP. For example, a component “reg_A” is linked to a source code of “reg_A”. The “attribute” stores therein characteristics concerning the component (the register). The “specification” stores therein pointers to the specification of the component (the register). For example, a component “reg_A” is linked to “specification reg_A” that is the specification data of “reg_A” in the IPDB 201. The “parent component” stores therein an IP name that is the parent of the IP of the register, and pointers to the IP. For example, a component “reg_A2” is a derivation of “reg_A” and is linked to a source code of “reg_A” .

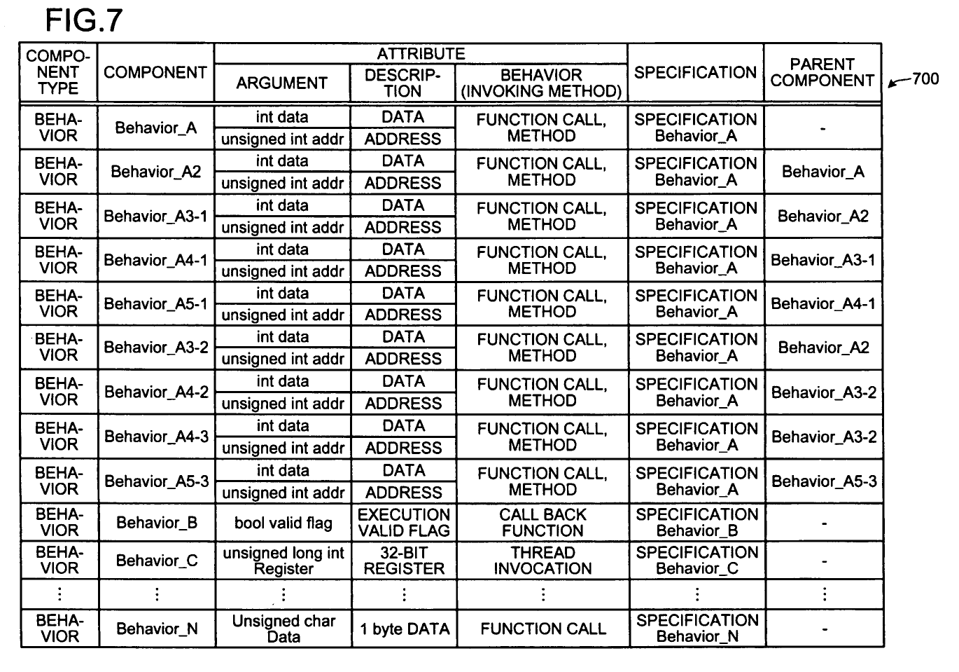

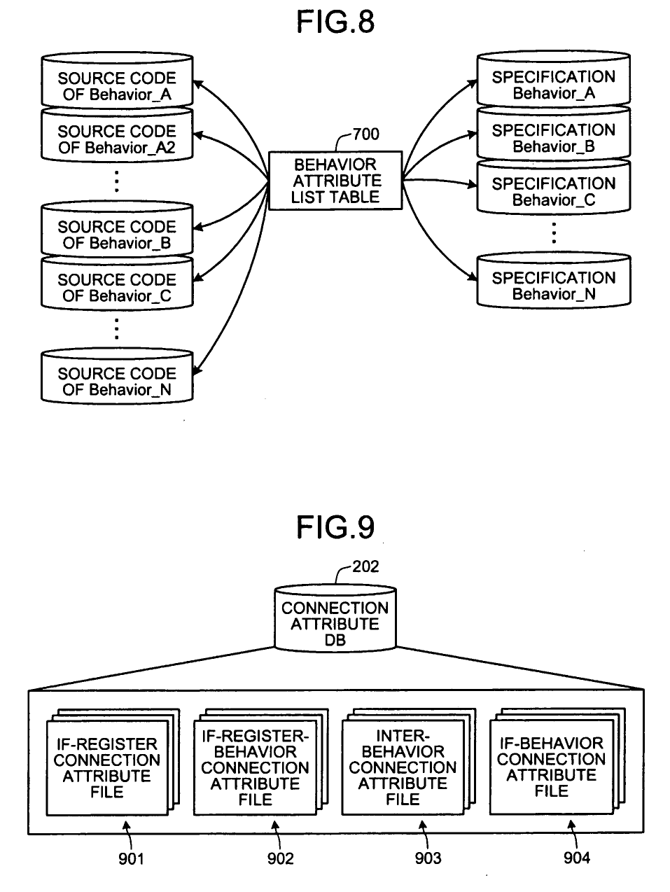

FIG. 7 is a diagram of a behavior attribute list table 700. FIG. 8 is a diagram of the relation between the behavior attribute list table 700 and source code. As depicted in FIG. 7, the behavior attribute list table 700 is a table that, among the three types of components (the IF, the register, and the behavior) included in an IP model, lists attributes of the behavior. The behavior attribute list table 700 stores therein the type of component, a component, an attribute, a specification, and a parent component for each record. The “type of component” indicates classification, such as a behavior of the IP.

The “component” is an IP name that identifies the specific content of the behavior of the IP, and stores therein a pointer to the IP. For example, a component “Behavior_A” is linked to a source code of “Behavior_A”. The “attribute” stores therein characteristics concerning the component (the behavior).

The “specification” stores therein a pointer to the specification concerning the component (the behavior). For example, a component “Behavior_A” is linked to “specification Behavior_A” that is the specification data of “Behavior_A”. The “parent component” stores therein the name of an IP that is a parent of the IP of the behavior and a pointer to the IP. For example, a component “Behavior_A2” is a derivation of “Behavior_A” and is linked to a source code of “Behavior_A”.

FIG. 9 is a diagram of the stored contents of the connection attribute DB 202. The connection attribute DB 202 stores therein a connection attribute file for mutual connections between IPs.

More specifically, the connection attribute DB 202 stores therein, for example, an IF-register connection attribute file group 901 that defines the connection relation between an IF and a register, an IF-register-behavior connection attribute file group 902 that defines the connection relation between an IF and a behavior through a register, an inter-behavior connection attribute file group 903 that defines the connection relation between behaviors, and an IF-behavior connection attribute file group 904 that defines the connection relation between an IF and a behavior. When a file group is newly created, the file group is newly entered.

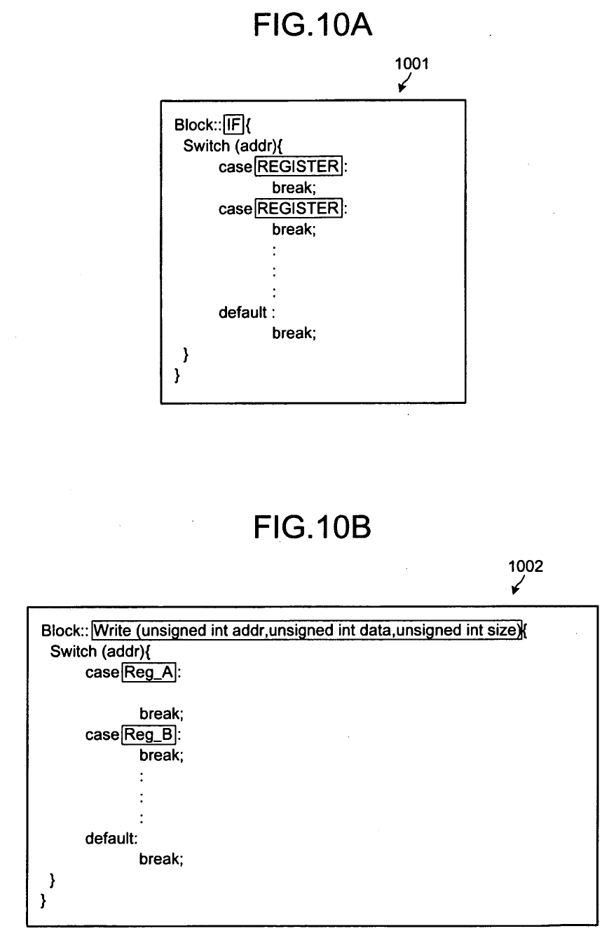

Specific examples of files in each of the above connection attribute file groups will be given. The description below is one example and other descriptions defining the connection relation exist in addition to the example. In FIGS. 10A to 14A, a description surrounded by a rectangle is a description concerning an IP and an IP can be arbitrarily selected by a designer. The selected IP is linked to a corresponding source code in the IPDB 201.

FIG. 10A is a diagram of an example of an IF-register connection attribute file. FIG. 10A depicts the connection relation between a specific API and a register. When a writing destination is selected according to data to be written, an IF-register connection attribute file 1001 is used.

FIG. 10B is a diagram of exemplary application of the IF-register connection attribute file depicted in FIG. 10A. FIG. 10B depicts the connection relation among “write( )” that is a specific API, “Reg_A” that is a register, and “Reg_B”. When a writing destination “Reg_A” or “Reg_B” is selected according to data to be written, the description is executed as in an IF-register connection attribute file 1002.

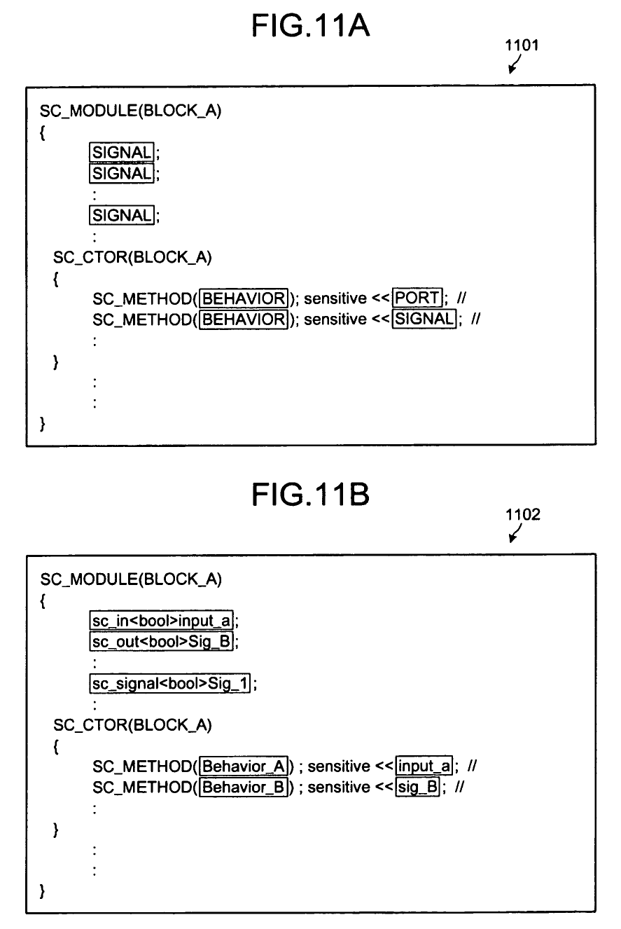

FIG. 11A is a diagram of an example of an IF-behavior connection attribute file. FIG. 11A depicts the connection relation between an IF and a behavior of a port, and the connection relation between an IF and a behavior of a signal. When a behavior is initiated using a port as a trigger or when a behavior is initiated using a signal, an IF-behavior connection attribute file 1101 is used.

FIG. 11B is a diagram of exemplary application of the IF-behavior connection attribute file depicted in FIG. 11A. FIG. 11B depicts the connection relation between “input_a” that is an IF and “Behavior_A” that is a behavior of a port, and the connection relation between “sig_1” that is an IF and “Behavior_B” that is a behavior of a signal. When “Behavior_A” is initiated using “input_a” as a trigger and “Behavior_B” is initiated using “sig_1” that is signal-defined, an IF-behavior connection attribute file 1102 is used.

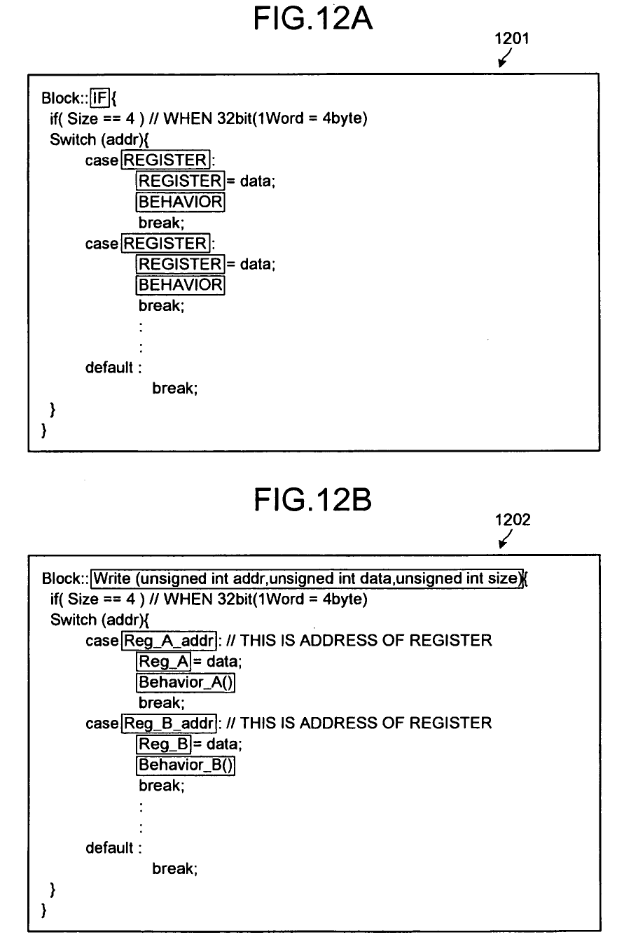

FIG. 12A is diagram of an example of an IF-register-behavior connection attribute file. FIG. 12A depicts the connection relation among a specific API, a register, and a behavior. When an execution object of writing and a writing destination are selected according to data to be written, an IT-register-behavior connection attribute file 1201 is used.

FIG. 12B is a diagram of exemplary application of the IF-register-behavior connection attribute file depicted in FIG. 12A. FIG. 12B depicts the connection relation among “write( )” that is a specific API, “Reg_A” that is a register and “Behavior_A( )” that is a behavior, and the connection relation among “write( )” that is the specific API, “Reg_B” that is a register and “Behavior_B( )” that is a behavior. When “Behavior_A” selectively writes into “Reg_A” or “Behavior_B( )” selectively writes into “Reg_B” according to data to be written, description is as an IF-register-behavior connection attribute file 1202.

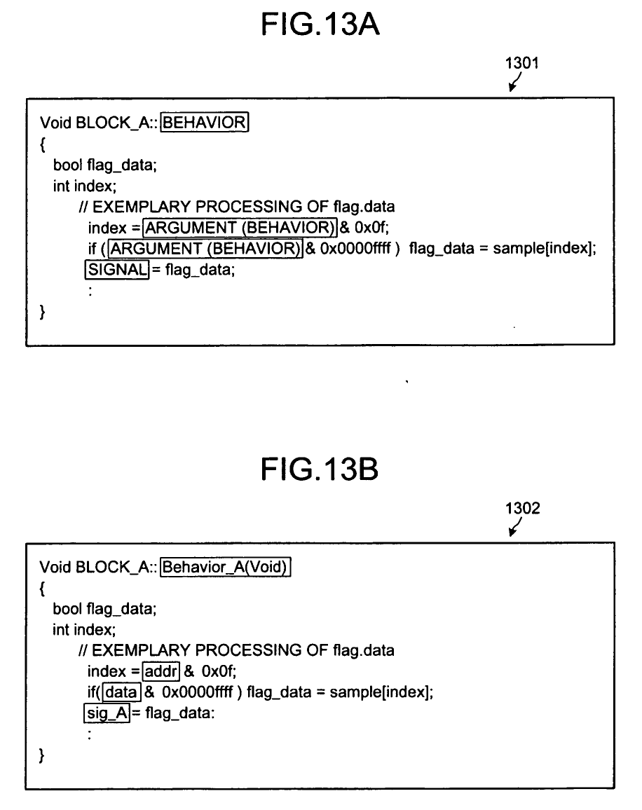

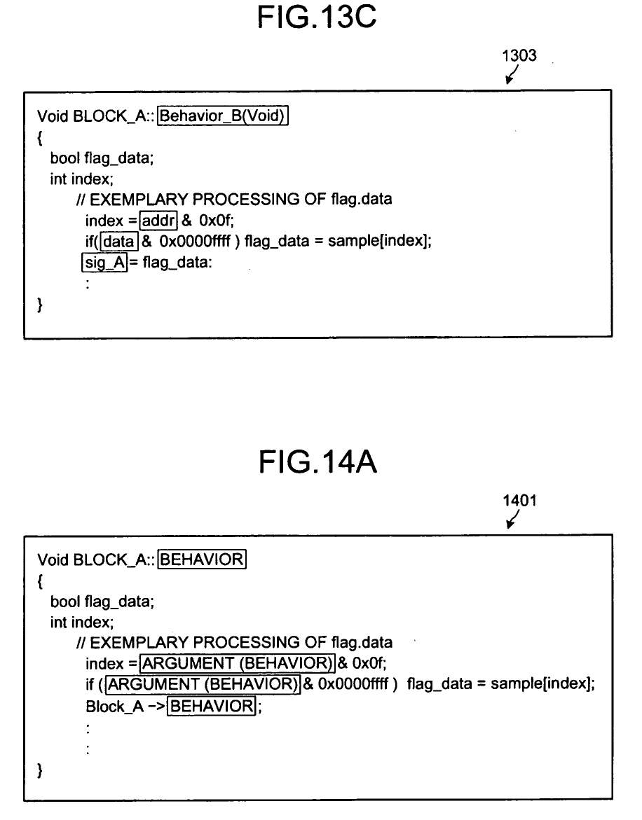

FIG. 13A is a diagram of an example of an IF-behavior connection attribute file. FIG. 13A depicts the connection relation between an IF and a behavior of a signal. When a signal is output by executing the behavior, an IF-behavior connection relation attribute file 1301 is used.

FIG. 13B is a diagram of an example of the IF-behavior connection attribute file depicted in FIG. 13A. FIG. 13B depicts the connection relation between “sig_A” that is an IF and “Behavior_A (void)” that is a behavior of a signal. When “sig_A” is output by executing “Behavior_A (void)”, description is as an IF-behavior connection attribute file 1302.

FIG. 13C is diagram of an example of the IF-behavior connection attribute file depicted in FIG. 13A. FIG. 13C depicts the connection relation between “sig_B” that is an IF and “Behavior_B (void)” that is a behavior of a signal. When “sig_B” is output by executing “Behavior_B (void)”, description is as an IF-behavior connection attribute file 1303.

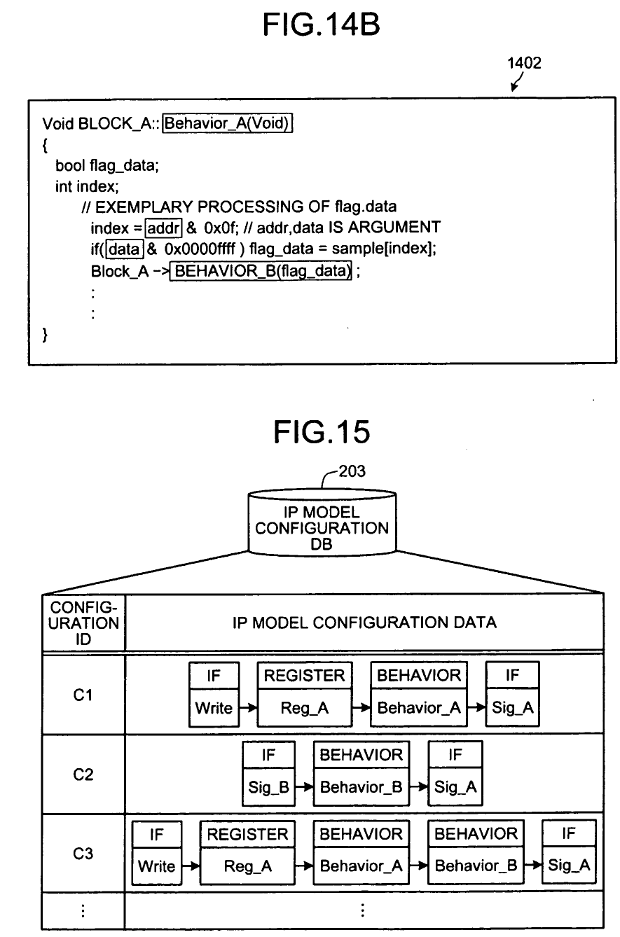

FIG. 14A is diagram of an example of an inter-behavior connection attribute file. FIG. 14A depicts the connection relation between a behavior and another behavior. When a behavior is executed and another behavior is executed using data that is the result of the execution of the behavior, an inter-behavior connection attribute file 1401 is used.

FIG. 14B is a diagram of an example of the inter-behavior connection attribute file depicted in FIG. 14A. FIG. 14B depicts the connection relation between “Behavior_A” and “Behavior_B” that are behaviors. When “Behavior_A” is executed and “Behavior_B” is executed using data that is the result of the execution of “Behavior_A”, an inter-behavior connection attribute file 1402 is used.

FIG. 15 is a diagram of the stored contents of the IP model configuration DB 203. As depicted in FIG. 15, the IP model configuration DB 203 stores therein a configuration ID and IP model configuration data for each record. The “configuration ID” is identification information that identifies the IP model configuration data. The IP model configuration data is data created by a designer, and is indicative of the block configuration of an IP model to be designed. As with FIG. 1, a rectangular block represents the IP, which is an IF, a register, or a behavior. An arrow between IPs represents a mutual connection relation between IPs.

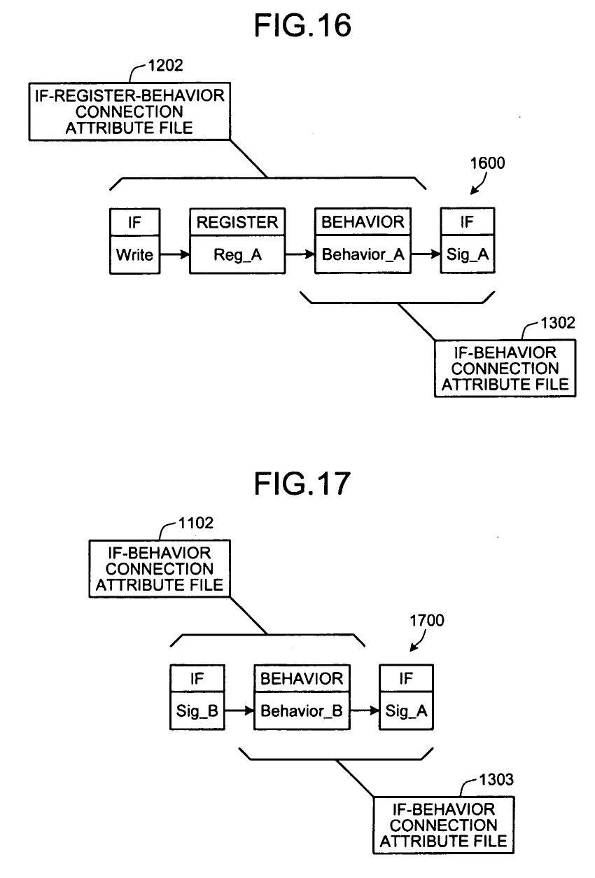

FIG. 16 is a diagram of IP model configuration data of the configuration ID: C1. As depicted in FIG. 16, in IP model configuration data 1600, the IF-register-behavior connection attribute file 1202 depicted in FIG. 12B and the IF-behavior connection attribute file 1302 depicted in FIG. 13B are linked.

FIG. 17 is a diagram of IP model configuration data of the configuration ID: C2. As depicted in FIG. 17, in IP model configuration data 1700, the IF-behavior connection attribute file 1102 depicted in FIG. 11B, and the IF-behavior connection attribute file 1303 depicted in FIG. 13C are linked.

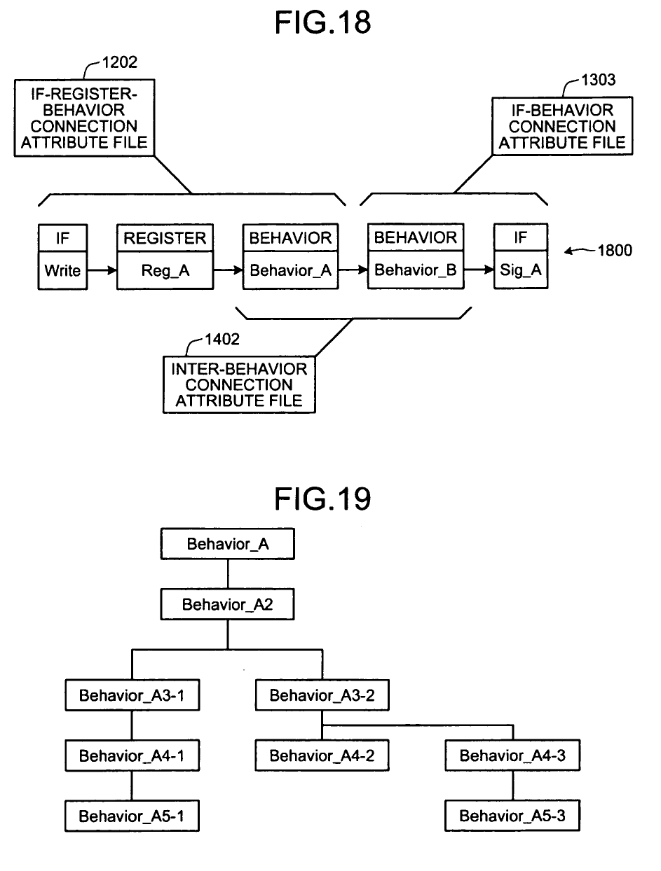

FIG. 18 is a diagram of IP model configuration data of the configuration ID: C3. As depicted in FIG. 18, in IP model configuration data 1800, the IF-register-behavior connection attribute file 1202 depicted in FIG. 12B and the IF-behavior connection attribute file 1303 depicted in FIG. 13C are linked.

FIG. 19 is a diagram of the relation with derived items. A derived item is a source code of an IP that is improved from a parent component (see FIGS. 3, 5, and 7). A derived item forms a tree structure from a source code that is an ancestor as a root. FIG. 19 concerns a behavior “Behavior_A”. As depicted in FIG. 7, a tree structure as depicted in FIG. 19 can be obtained by linking each behavior to a parent component. The derived item can be defined by a connection attribute file.

The tree structure is referred to as a “derived item list”. A derived item list is called when an IP (rectangular block) of an IP model configuration data is selected. As depicted by the derived item list in FIG. 19, for example, when “Behavior_A”, which is the behavior depicted in FIG. 16, is selected by a designer, a computer acquires “Behavior_A2” as a behavior having “Behavior_A” as a parent component; and the computer acquires “Behavior_A3-1” and “Behavior_A3-2” as behaviors having “Behavior_A2” as a parent component. Through repetition of such acquiring until no behavior is obtained, the derived item list is automatically obtained.

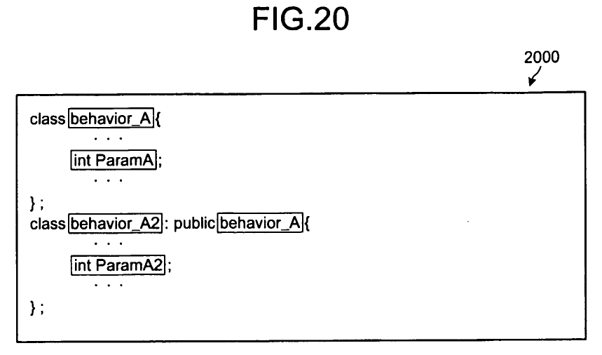

FIG. 20 is a diagram of a specific example of a connection attribute file used when derived items are created. As depicted in FIG. 20, a connection attribute file 2000 depicts the connection relation by class succession. “Behavior_A” has a parameter “ParamA” and “Behavior_A2” has a parameter “ParamA2”. “Behavior_A2” has “ParamA2” and further has a parameter of “Behavior_A”. That is, “Behavior_A2” is developed as a derived item of “Behavior_A”. The development of a derived item is not limited to this approach. A designer makes additions and changes to the source code of a parent component and enters an obtained source code into the IPDB 201 and, thereby, a derived item can be obtained. In this case, a pointer to the parent component is created.

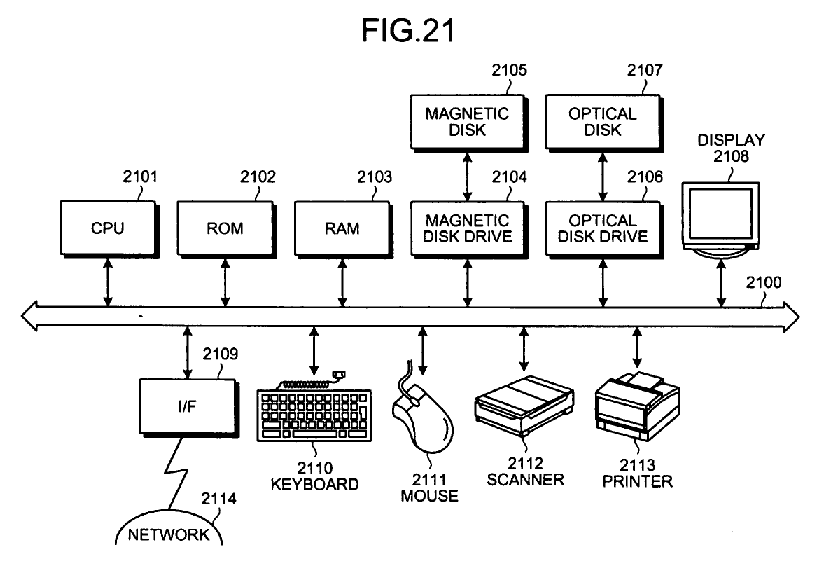

FIG. 21 is a block diagram of an IP model creating apparatus according to the embodiment. As depicted in FIG. 21, the IP model creating apparatus includes a central processing unit (CPU) 2101, a read-only memory (ROM) 2102, a random access memory (RAM) 2103, a magnetic disc drive 2104, a magnetic disc 2105, a optical disc drive 2106, an optical disc 2107, a display 2108, a register (interface (I/F)) 2109, a keyboard 2110, a mouse 2111, a scanner 2112, and a printer 2113, connected to one another by way of a bus 2100.

The CPU 2101 governs overall control of the IP model creating apparatus. The ROM 2102 stores therein programs such as a boot program. The RAM 2103 is used as a work area of the CPU 2101. The magnetic disc drive 2104, under the control of the CPU 2101, controls reading/writing of data from/to the magnetic disc 2105. The magnetic disc 2105 stores therein the data written under control of the magnetic disc drive 2104.

The optical disc drive 2106, under the control of the CPU 2101, controls reading/writing of data from/to the optical disc 2107. The optical disc 2107 stores therein the data written under control of the optical disc drive 2106, the data being read by a computer.

The display 2108 displays, for example, data such as texts, images, functional information, etc., in addition to a cursor, icons, or tool boxes. A cathode ray tube (CRT), a thin-film-transistor (TFT) liquid crystal display, a plasma display, etc., may be employed as the display 2108.

The I/F 2109 is connected to a network 2114 such as a local area network (LAN), a wide area network (WAN), and the Internet through a communication line and is connected to other apparatuses through the network 2114. The register 2109 administers an internal interface with the network 2114 and controls the input/output of data from/to external apparatuses. For example, a modem or a LAN adaptor may be employed as the register 2109.

The keyboard 2110 includes, for example, keys for inputting letters, numerals, and various instructions and performs the input of data. Alternatively, a touch-panel-type input pad or numeric keypad, etc. may be adopted. The mouse 2111, for example, performs the movement of the cursor, selection of a region, or movement and size change of windows. Alternatively, a track ball or a joy stick may be adopted provided each respectively has a function similar to a pointing device.

The scanner 2112 optically reads an image and takes in the image data into the IP model creating apparatus. The scanner 2112 may have an optical character recognition (OCR) function as well. The printer 2113 prints image data and document data. The printer 2113 may be, for example, a laser printer or an ink jet printer.

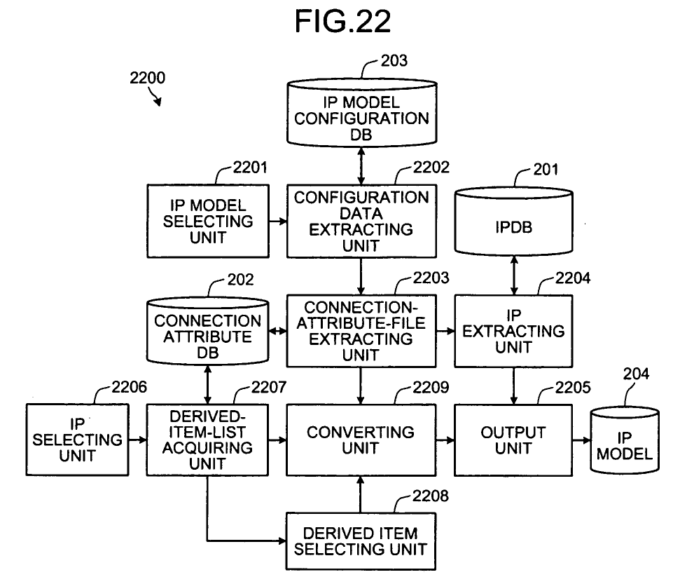

FIG. 22 is a block diagram of a functional configuration of the IP model creating apparatus. An IP model creating apparatus 2200 includes the IPDB 201, the connection attribute DB 202, the IP model configuration DB 203, an IP model selecting unit 2201, a configuration data extracting unit 2202, a connection-attribute-file extracting unit 2203, an IP extracting unit 2204, an output unit 2205, an IP selecting unit 2206, a derived-item-list acquiring unit 2207, a derived item selecting unit 2208, and a converting unit 2209.

More specifically, functions constituting a control unit (the IP model selecting unit 2201 to the converting unit 2209) are implemented by, for example, causing the CPU 2101 to execute a program stored in a storage area such as the ROM 2102, the RAM 2103, the magnetic disc 2105, or the optical disc 2107, or by the I/F 2109 depicted in FIG. 21. More specifically, the IPDB 201, the connection attribute DB 202, and the IP model configuration DB 203 realize respective functions using a storage area such as the ROM 2102, the RAM 2103, the magnetic disc 2105, and the optical disc 2107 depicted in FIG. 21.

The IP model selecting unit 2201 has a function of receiving the selection of an IP model for a diverted use. More specifically, for example, when the stored contents of the IP model configuration DB 203 depicted in FIG. 15 is displayed on a display 2108, the configuration ID of the IP model configuration data that is the target of the diverted use is selected using a mouse, etc.

The configuration data extracting unit 2202 has a function of extracting from the IP model configuration DB 203, the configuration data of the IP model selected through the IP model selecting unit 2201. More specifically, for example, the selected configuration ID is sent to the IP model configuration DB 203 using the selection of the configuration ID as a trigger and the IP model configuration data identified by the selected configuration ID is read.

The connection-attribute-file extracting unit 2203 has a function of extracting from the connection attribute database, a connection attribute file that defines the connection relation between IPs defined by the IP model configuration data extracted by the configuration data extracting unit 2202. More specifically, the connection-attribute-file extracting unit 2203 reads from the connection attribute DB 202 the connection attribute file linked to the extracted IP model configuration data. For example, when IP model configuration data 1700 depicted in FIG. 17 is extracted, the connection-attribute-file extracting unit 2203 reads the IF-behavior connection attribute files 1102 and 1103.

The IP extracting unit 2204 has a function of extracting from the IPDB 201, a source code of an IP defined by the configuration data extracted by the configuration data extracting unit 2202. A connection attribute file has embedded therein a pointer to an IP to be connected and, therefore, the IP extracting unit 2204 reads from the IPDB 201, the source code of the corresponding IP using the pointer.

The output unit 2205 has a function of outputting, as the IP model for the diverted use, the connection attribute file extracted by the connection-attribute-file extracting unit 2203 and the source code of the IP extracted by the IP extracting unit 2204. More specifically, for example, the output unit 2205 outputs the connection attribute file and the source code of the IP that are extracted, as they are. The output unit 2205 may output the connection attribute file and the source code of the IP collectively as a single file. The output format of an IP model may be displayed on a display, output by printing using a printer, transmitted to an external computer, written to a storage area, etc.

The IP selecting unit 2206 has a function of receiving the selection of an IP in the configuration data extracted by the configuration data extracting unit 2202. More specifically, for example, when the IP model configuration data is displayed on the display, an IP is selected using a mouse, etc.

The derived-item-list acquiring unit 2207 acquires a derived item list of the selected IP using the selection of the IP through the IP selecting unit 2206 as a trigger. More specifically, for example in FIG. 19, when the behavior “Behavior_A” is selected, the computer accesses the connection attribute DB 202 and acquires “Behavior_A2” as a behavior having “Behavior_A” as a parent component and the computer acquires “Behavior_A3-1” and “Behavior_A3-2” as behaviors having “Behavior_A2” as a parent component. Such acquiring is repeated until no behavior is acquired and, thereby, the derived item list is automatically obtained.

The derived item selecting unit 2208 has a function of receiving the selection of derived items of the IP selected through the IP selecting unit 2206. More specifically, for example, when the derived item list is displayed on the display, a derived item is selected using the mouse, etc.

The converting unit 2209 has a function of converting the IP that is selected through the IP selecting unit 2206 and in the connection attribute file extracted by the connection-attribute-file extracting unit 2203, into the derived item selected through the derived item selecting unit 2208. More specifically, when the selection of the derived item is received, the converting unit 2209 converts the description of the selected IP in the connection attribute file into the description of the selected derived item. For example, when the behavior “Behavior_A” is converted into the derived item “Behavior_A2” in the IP model configuration data 1600 of FIG. 16, the converting unit 2209 converts “Behavior_A ( )” in the IF-register-behavior connection attribute file 1202 having the behavior “Behavior__A” described therein, into “Behavior_A2( )”.

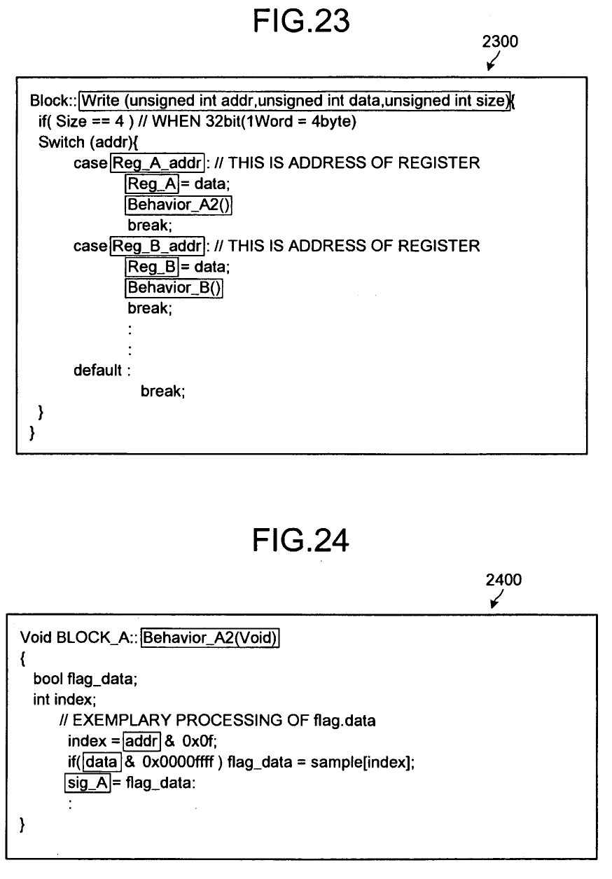

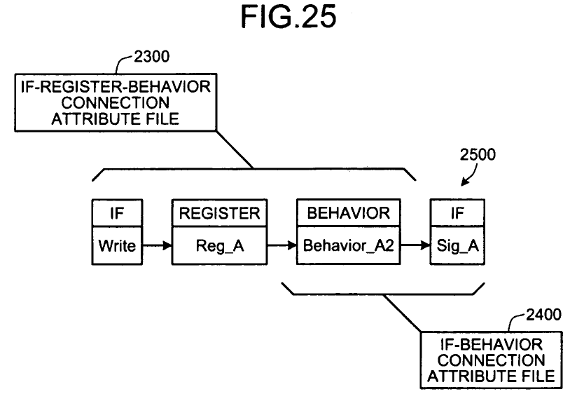

FIG. 23 is a diagram of an IF-register-behavior connection attribute file 2300 after conversion. Similarly, the converting unit 2209 converts “Behavior_A (void)” in the IF-behavior connection attribute file 1302 into “Behavior_A2”. FIG. 24 is a diagram of an IF-register-behavior connection attribute file 2400 after conversion. FIG. 25 is a diagram of IP model configuration data 2500 after conversion.

In this manner, the IP extracting unit 2204 extracts from the IPDB 201, a source code of the derived item described in the connection attribute file converted by the converting unit 2209. The IF-register-behavior connection attribute file 2300 and the IF-register-behavior connecting attribute file 2400 that each are obtained by the conversion are entered (newly registered) into the connection attribute DB 202. The IP model configuration data 2500 is entered (newly registered) into the IP model configuration DB 203.

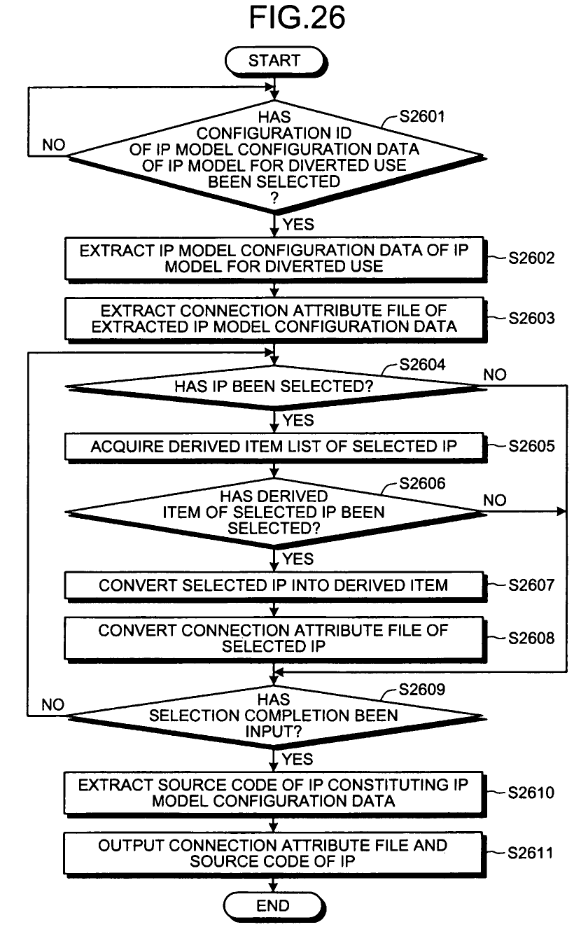

FIG. 26 is a flowchart of an IP model creating process performed by the IP model creating apparatus. The flowchart depicts the procedure of the automatic execution by the IP model creating apparatus. Waiting occurs for the selection (through the IP model selecting unit 2201) of the configuration ID of the IP model configuration data of an IP model for diverted use (step S2601: NO).

When the selection is executed (step S2601: YES), the configuration data extracting unit 2202, using the configuration ID as a clue, extracts from the IP model configuration DB 203, the IP model configuration data of the IP model for diverted use (step S2602). The connection-attribute-file extracting unit 2203 extracts from the connection attribute DB 202, the connection attribute file of the extracted IP model configuration data (step S2603).

Whether an IP of the extracted IP model configuration data has been selected is determined (step S2604). When an IP has not been selected (step S2604: NO), the procedure proceeds to step S2609. When an IP has been selected (step S2604: YES), the derived-item-list acquiring unit 2207 acquires the derived item list of the selected IP (step S2605). When the derived-item-list acquiring unit 2207 has already acquired the derived item list, the procedure advances to step S2606.

When a derived item of the selected IP has not been selected (step S2606: NO), the procedure advances to step S2609. Conversely, when a derived item of the selected IP has been selected (step S2606: YES), the selected IP on the IP model configuration data is converted into the derived item and the selected IP described in the connection attribute file is converted into the derived item (step S2607) and, thereby, the connection attribute file is converted (step S2608).

Subsequently, the procedure advances to step S2609. At step S2609, whether selection completion has been input is determined (step S2609). When selection completion has not been input (step S2609: NO), the procedure returns to step S2604. Conversely, when selection completion has been input (step S2609: YES), the IP extracting unit 2204 extracts from the IPDB 201, the source code of the IP (including the derived item) constituting the IP model configuration data (if conversion into the derived item has been executed, the IP model configuration data after the conversion at step S2608) extracted at step S2602 (step S2610).

The output unit 2205 outputs the connection attribute file and the source code of the IP (step S2611). Thereby, the IP model creating process ends. Subsequently, when necessary, a wrapper may be created and may be connected to an external IF.

As described, according to the embodiment, by classifying the types of components of an IP model into only three types, i.e., an IF, a register, and a behavior, the types can be localized according to the connection attributes, which is simple description content. An IP model can be represented by combining the connection attributes.

Thus, improvement of reusability of the connection attributes between IPs that constitute the IP model can be achieved. By division of each processing and localization of points to be corrected, reusability can be improved. With this localization, strict selection of the scope of the verification of a derivation can be executed. Therefore, all types need not be assimilated as a template and template codes do not explosively increase for each type. Hence, the readability of the source codes is not impaired and no bugs are propagated. Thus, improvement of the quality of the IP model is achieved.

The intellectual property creating method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A model managing apparatus that manages an intellectual property model formed by using program description to model a function to be realized as hardware, the model managing apparatus comprising
a data storing unit that stores and manages therein electronic system levels that are components into which the intellectual property model is divided, the components being an application program interface that defines external communications, a register that defines data to be input and output, and a behavior that defines a function or a computation, wherein
the data storing unit further stores therein connection data that defines connection relations between the register and the behavior, between behaviors, and between the behavior and the application program interface.

2. A model creating apparatus that designs an intellectual property model formed by using program description to model a function to be realized as hardware, comprising:
a data storing unit that stores therein electronic system levels that are components forming the intellectual property model, the components being an application program interface that defines external communications, a register that defines data to be input and output, and a behavior that defines a function or a computation;
an extracting unit that extracts from the data storing unit, an electronic system level appropriate for the function that is to be realized as hardware; and
a model creating unit that, based on the electronic system level extracted by the extracting unit, creates data that defines connection relations between the register and the behavior, between behaviors, and between the behavior and the application program interface.

3. A model creating method of designing an intellectual property model formed by using program description to model a function to be realized as hardware, comprising:
extracting an electronic system level appropriate for the function that is to be realized as hardware, from a data storing unit that stores therein electronic system levels that are components forming the intellectual property model, the components being an application program interface that defines external communications, a register that defines data to be input and output, and a behavior that defines a function or a computation; and
creating, based on the electronic system level extracted at the extracting, data that defines connection relations between the register and the behavior, between behaviors, and between the behavior and the application program interface.

4. A model creating apparatus capable of accessing an intellectual property database that stores therein source code of an intellectual property that is divided into an interface indicative of input and output of data, a register that stores the data, and a behavior that executes processing based on the data; a connection attribute database that stores therein a connection attribute file defining a connection relation between intellectual properties; and an intellectual property model configuration database that stores therein configuration data indicative of a configuration of an intellectual property model that is defined by the intellectual property and the connection attribute file, the model creating apparatus comprising:
a selecting unit that receives selection of an intellectual property model for diverted use;
a configuration data extracting unit that extracts from the intellectual property model configuration database, configuration data concerning the intellectual property model selected through the selecting unit;
a connection attribute file extracting unit that extracts from the connection attribute database, a connection attribute file defining a connection relation between intellectual properties defined by the configuration data extracted by the configuration data extracting unit;
an intellectual property extracting unit that extracts from the intellectual property database, source code of an intellectual property defined by the configuration data extracted by the configuration data extracting unit; and
an output unit that outputs the connection attribute file extracted by the connection attribute file extracting unit and the source code extracted by the intellectual property extracting unit, as the intellectual property model for diverted use.

5. The model creating apparatus according to claim 4, further comprising:
an intellectual property selecting unit that receives selection of an intellectual property in the configuration data extracted by the configuration data extracting unit;
a derived item selecting unit that receives selection of a derived item of the intellectual property selected through the intellectual property selecting unit; and
a converting unit that, with respect to the connection attribute file extracted by the connection attribute file extracting unit, converts the intellectual property selected through the intellectual property selecting unit into the derived item selected through the derived item selecting unit, wherein
the intellectual property extracting unit extracts from the intellectual property database, source code of the derived item described in the connection attribute file converted by the converting unit.

6. A model creating method of a computer capable of accessing an intellectual property database that stores therein source code of an intellectual property that is divided into an interface indicative of input and output of data, a register that stores the data, and a behavior that executes processing based on the data; a connection attribute database that stores therein a connection attribute file defining a connection relation between intellectual properties; and an intellectual property model configuration database that stores therein configuration data indicative of a configuration of an intellectual property model that is defined by the intellectual property and the connection attribute file, the model creating method comprising:
receiving selection of an intellectual property model for diverted use;
extracting from the intellectual property model configuration database, configuration data concerning the intellectual property model for which selection is received at the receiving;
extracting from the connection attribute database, a connection attribute file defining a connection relation between intellectual properties defined by the configuration data extracted at the extracting the configuration data;
extracting from the intellectual property database, source code of an intellectual property defined by the configuration data extracted at the extracting the configuration data; and
outputting the connection attribute file extracted at the extracting the connection attribute file and the source code extracted at the extracting the intellectual property, as the intellectual property model for diverted use.

7. The model creating method according to claim 6, further comprising:
receiving selection of an intellectual property in the configuration data extracted at the extracting the configuration data;
receiving selection of a derived item of the intellectual property for which selection is received at the receiving selection of the intellectual property; and
converting, with respect to the connection attribute file extracted at the extracting the connection attribute file, the intellectual property for which selection is received at the receiving selection of the intellectual property into the derived item for which selection is received at the receiving selection of the derived item, wherein
the extracting the intellectual property includes extracting from the intellectual property database, source code of the derived item described in the connection attribute file converted at the converting.

8. A computer-readable recording medium storing therein a program that, with respect to a computer capable of accessing an intellectual property database that stores therein source code of an intellectual property that is divided into an interface indicative of input and output of data, a register that stores the data, and a behavior that executes processing based on the data; a connection attribute database that stores therein a connection attribute file defining a connection relation between intellectual properties; and an intellectual property model configuration database that stores therein configuration data indicative of a configuration of an intellectual property model that is defined by the intellectual property and the connection attribute file, causes the computer to execute:
receiving selection of an intellectual property model for diverted use;
extracting from the intellectual property model configuration database, configuration data concerning the intellectual property model for which selection is received at the receiving;
extracting from the connection attribute database, a connection attribute file defining a connection relation between intellectual properties defined by the configuration data extracted at the extracting the configuration data;
extracting from the intellectual property database, source code of an intellectual property defined by the configuration data extracted at the extracting the configuration data; and
outputting the connection attribute file extracted at the extracting the connection attribute file and the source code extracted at the extracting the intellectual property, as the intellectual property model for diverted use.

9. The computer-readable recording medium according to claim 8, the program further causing the computer to execute:
receiving selection of an intellectual property in the configuration data extracted at the extracting the configuration data;
receiving selection of a derived item of the intellectual property for which selection is received at the receiving selection of the intellectual property; and
converting, with respect to the connection attribute file extracted at the extracting the connection attribute file, the intellectual property for which selection is received at the receiving selection of the intellectual property into the derived item for which selection is received at the receiving selection of the derived item, wherein
the extracting the intellectual property includes extracting from the intellectual property database, the source code of the derived item described in the connection attribute file converted at the converting.
